(19) United States
(12) Patent Application Publication
(10) Pub. No.: US 2024/0199442 A1
(43) Pub. Date: Jun. 20, 2024

(54) INSTALLATION FOR TREATING WASTEWATER FROM A TOILET AND SANITARY UNIT COMPRISING SUCH AN INSTALLATION

(71) Applicant: MIZUFALLS SA, Genève (CH)

(72) Inventors: Jonathan CAVALCANTI, Geneve (CH); Antoine COTTET, Onex (CH); Christophe DE MATOS, Geneve (CH)

(21) Appl. No.: 18/288,272

(22) PCT Filed: Apr. 26, 2021
(86) PCT No.: PCT/IB2022/053839

§ 371 Date: Oct. 25, 2023

(30) Foreign Application Priority Data
Apr. 27, 2021 (CH) 00453/21
Apr. 27, 2021 (FR) FR2104381

(51) Int. Cl. C02F 1/00; B01D 29/68; B01D 33/073; B01D 33/50; B01D 61/14; B01D 61/16; B01D 61/18; C02F 1/44; C02F 103/00; E03D 1/00; E03D 9/00

(52) U.S. Cl. CPC C02F 1/001; B01D 29/68; B01D 33/073; B01D 33/50; B01D 61/145; B01D 61/16; B01D 61/18; C02F 1/444; E03D 1/00; E03D 9/00; C02F 2103/005; C02F 2301/046; C02F 2303/16

(57) ABSTRACT

The invention relates to an installation (5) for treating wastewater from a toilet (3), comprising a solid/liquid separation filter (25) and a liquid recirculation circuit (27) for conveying a liquid from said filter to a tank (11). The installation (5) is characterised in that the filter (25) has an inlet intended to be connected to a bowl, a solid/liquid separation module, a first outlet connected to a discharge pipe (30) and a second outlet connected to the recirculation circuit, said filter (25) conveying the solid materials to said first outlet and the liquid materials to said second outlet, said installation also being characterised in that said recirculation circuit comprises a filtration assembly designed to make said liquid reusable. The invention also relates to a sanitary unit (I) comprising such an installation.

### TECHNICAL FIELD AND PRIOR ART

The present invention relates to an installation for treating wastewater from a toilet and a sanitary unit comprising such an installation.

In the field of sanitary installations, controlling water consumption is a recurring problem, the impact being both economic and ecological.

More particularly, with regard to the field of toilets or water closets, referred to by the acronym “WC” hereinafter in the description, the number of people with access to WC with a flush system is constantly increasing in the world due to the increase in the world population.

In an attempt to control such consumption, numerous solutions of the prior art aim to reduce the volume of water needed for the operation of flush systems.

Another solution of the prior art is the solution referred to in document U.S. Pat. No. 5,045,188, which provides an installation including a complete sanitary unit, further including a WC and a circuit for recirculating the wastewater coming from the WC.

However, such unit has several drawbacks.

First, the design of the wastewater treatment installation is particularly complex.

The installation further includes a tank mounted under the WC bowl, making the use of the installation incompatible with an already existing WC.

Then, the solid matter is recovered in a tank intended for being manually emptied. Thereby, there is no automatic connection to a discharge pipe for solid matter.

Also, the filters used do not guarantee a sufficiently good quality for the water recovered at the outlet of the recirculation circuit

Moreover, the installation is not connected to an external water inlet.

Finally, the functioning of the WC is not guaranteed during a power cut, electricity being necessary for making the installation work.

### Outline of the Invention

The present invention aims to overcome the aforementioned drawbacks, and, to this end, relates to an installation for treating wastewater from a WC, comprising:
a solid/liquid separation filter intended for being mounted on the outlet of a WC bowl, and
a liquid recirculation circuit, arranged for conveying a liquid from said separation filter to a main tank of said WC,
the installation being remarkable in that the solid/liquid separation filter includes at least:
an inlet, intended for being connected to the outlet of the bowl of said WC,
a solid/liquid separation module, designed for separating solid matter from liquids,
a first outlet, intended for being connected to the inlet of a discharge pipe,
a second outlet, connected to said liquid recirculation circuit,
the separation filter being designed for conveying solid matter from said separation module to said first outlet and for conveying liquids from said separation module to said second outlet,
said installation being further remarkable in that said liquid recirculation circuit comprises a filtration unit designed for making said liquid reusable after said liquid has gone through said filtration unit.

Thereby, by providing for equipping the installation of the invention with a solid/liquid separation filter including an inlet intended for being connected to the outlet of the bowl of a WC, the installation of the invention can be mounted on an already existing WC.

The mounting of the installation is then greatly simplified while leaving the choice of the WC to the user.

“Reusable water” means water the quality of which meets local standards for use in flushing. Requirements may vary from one country to another. The invention makes it possible e.g. to obtain, if so required, reusable water, i.e. suitable for consumption, but it should be noted that such a level of quality is not necessary for ensuring the function of a flush.

As a result, the manufacturing cost of the installation is optimized.

Also, equipping the recirculation circuit with a filtration unit designed for making the liquid coming from the separation filter reusable makes it possible to set up a closed circuit, considerably reducing the quantity of water necessary for the functioning of a WC equipped with the installation of the invention.

According to optional features of the installation according to the invention:
the filtration unit of the liquid recirculation circuit comprises a prefiltration system and an ultrafiltration system, mounted in series. As a result, it is possible to obtain in a particularly simple way, a filtration unit designed for making the water at the outlet of the ultrafiltration system reusable;
in one embodiment, the solid/liquid separation filter includes a housing inside which is mounted the solid/liquid separation module, and the solid/liquid separation module is a rotary screen controlled by an electric motor;
in one embodiment, the separation filter includes a nozzle for cleaning the rotary screen, and the installation includes a cleaning pipe, connected at one of the ends thereof to said cleaning nozzle, and intended for being connected, at the other of the ends thereof, to a water inlet. By connecting the separation filter directly to a water inlet, the cleaning of the separation filter is optimized;
in one embodiment, the installation includes a storage tank for liquid matter, fed by the second outlet of the separation filter, and a hydraulic pump, arranged for extracting the liquid matter contained in said storage tank;
in one embodiment, the installation includes a system for draining the storage tank of liquids including a prefiltration pipe connecting the storage tank to the prefiltration system, an drain pipe connected to said prefiltration pipe and intended for being connected to the discharge pipe, and a unit for controlling the direction of flow of liquid matter, arranged in the installation for conveying the liquid matter from the storage tank to the discharge pipe;
in one embodiment, the installation includes a backwash system of the prefiltration system, further comprising a prefiltration pipe to which the prefiltration system is connected, a washing pipe, connected to said prefiltration system and intended for being connected to a water inlet, a drain pipe connected to said prefiltration pipe and intended for being connected to the discharge pipe, and a unit for controlling the direction of flow of the water, arranged in the installation for conveying water from a water inlet to the prefiltration system, then from the prefiltration system to the discharge pipe;
in one embodiment, the storage tank for liquid matter includes an upper cover having an opening receiving the second outlet of the solid/liquid separation filter;
in one embodiment, the solid/liquid separation filter includes two arms for attaching the prefiltration system and the ultrafiltration system.

The present invention further relates to a sanitary unit, remarkable in that it comprises:
a WC, comprising a WC bowl and a flush system, said flush system comprising a main tank, said main tank being connected to a water inlet and to said WC bowl, and
an installation according to the invention, for the treatment of the wastewater of said WC.

### BRIEF DESCRIPTION OF DRAWINGS

Other features, goals and advantages of the invention will appear upon reading the following description, the understanding of which will be supported by the enclosed drawings, wherein:

FIG. 1 schematically shows the sanitary unit according to the invention, in rear isometric view.

FIG. 2 illustrates the solid/liquid separation filter of the invention.

FIG. 3 is an enlargement of the zone III shown in FIG. 2.

FIG. 4 is an enlargement of the zone IV shown in FIG. 2.

FIG. 5 schematically represents the sanitary unit of the invention, in rear isometric view.

FIG. 6 is a hydraulic diagram of the sanitary unit of the invention.

FIG. 7 shows an embodiment of the arrangement between the solid/liquid separation filter and the storage tank of the installation of the invention.

### DETAILED DESCRIPTION OF EMBODIMENTS

In all the figures, identical or similar references represent identical or similar elements or assemblies of elements.

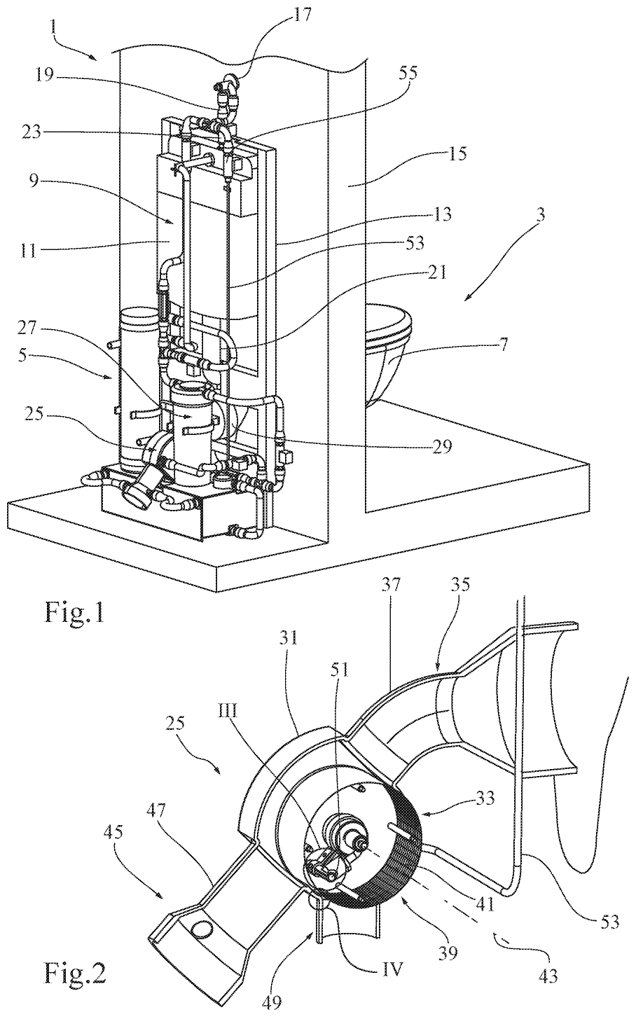

Reference is made to FIG. 1 which represents schematically a sanitary unit 1 according to the invention, in rear isometric view.

The sanitary unit 1 comprises a water closet 3, designated in the rest of the description and in the claims by the acronym “WC”, and an installation 5 for treating the wastewater of the WC 3.

The WC 3 comprises a bowl 7 and a flush system 9. The flush system 9 comprises, in a known manner, a main tank 11 which can be supported by a frame 13 mounted behind a partition 15 separating the bowl 7 from the flush system 9, the latter not being visible to a user. The main tank 11 is connected to a water inlet 17 via a water inlet pipe 19 and to the bowl 7 via a flow pipe 21. A supply valve 23, e.g. an electrically controlled hydraulic valve, is mounted on the water inlet pipe 19 in order to control the water supply of the main tank 11 via the water inlet 17.

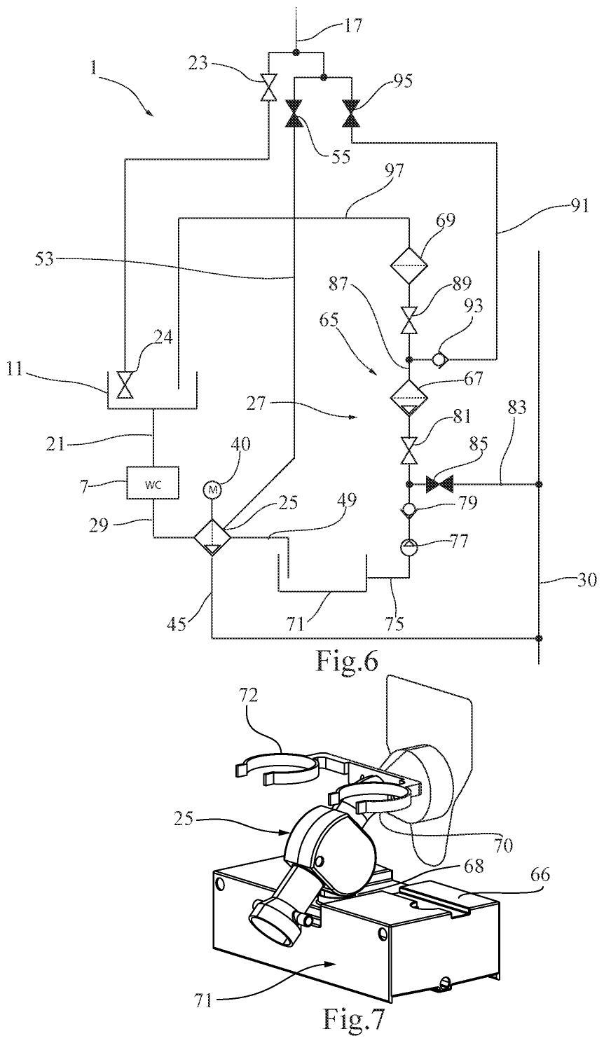

The main tank 11 contains a float valve system 24, not visible in FIG. 1, but shown in FIG. 6, the operation of which is well known to a person skilled in the art. When the flush system 9 is actuated, a flap located at the bottom of the main tank 11 opens, releasing the water contained in the main tank 11, which flows into the bowl 7 via the flow pipe 21. The float valve system then detects the drop in the water level in the main tank 11 and opens the water inlet 17 until the water reaches a predetermined level initially set during the installation of the WC.

According to the invention, the waste water treatment installation 5 of the WC 3 includes a solid/liquid separation filter 25 and a liquid recirculation circuit 27.

The solid/liquid separation filter 25 is connected to an outlet 29 of the bowl 7 and is interfaced between the outlet 29 and a discharge pipe 30, not shown in FIG. 1, but visible in FIG. 6, which can be connected to a sewer pipe. The solid/liquid separation filter 25 is designed to separate the solid matter from the liquid matter flushed from the bowl 7 when the flush system 9 is actuated. The solid/liquid separation filter 25 connects the outlet 29 of the bowl 7 to the discharge pipe 30 and connects the outlet 29 to the liquid recirculation circuit 27. By design, the solid/liquid separation filter 25 separates the solid matter from the liquids that feed it and then conveys the solid matter into the discharge pipe 30 and the liquids into the liquid recirculation circuit 27.

Reference is made to FIG. 2 which shows an example of the embodiment of the solid/liquid separation filter 25.

The solid/liquid separation filter 25 includes a housing 31 inside which a solid/liquid separation module 33 is mounted. The casing 31 in fact comprises two half-casings, e.g. molded and assembled together. In FIG. 2, only one of the two half-casings is shown, so as to reveal the inside of the filter 25.

The filter 25 includes an inlet 35 connected to the outlet 29 of the bowl 7 of the WC 3, acting as a drain coming out into the solid/liquid separation module 33. To this end, the inlet 35 has a slope 37 for letting the solid and liquid matter flow from the bowl 7 to the solid/liquid separation module 33.

According to the example of embodiment of the filter 25 shown in FIG. 2, the solid/liquid separation module 33 is made by a rotary screen 39, controlled by means of a motor 40 not shown in FIG. 2, but visible in FIG. 6, e.g. an electric motor. The rotary screen 39 has a cylindrical perforated sheet 41 rotated by the electric motor about an axis of rotation axis 43.

The rotation of the cylindrical perforated sheet moves the solid matter from the inlet 35 to a first outlet 45 of the solid/liquid separation filter 25. The first outlet 45 is connected to the discharge pipe 30 (visible in FIG. 6), which can be connected to a sewer pipe. The first outlet 45 has a slope 47 for letting the solid matter flow from the solid/liquid separation module 33 to the discharge pipe 30.

The solid/liquid separation filter 25 has a second outlet 49 which is connected to the liquid recirculation circuit 27 (visible in FIG. 1). The solid/liquid separation filter 25 is designed for conveying the liquid matter from the separation module 33 to the second outlet 49. To do this, the second outlet 49 is positioned under the cylindrical perforated sheet 41, so that the liquid matter coming from the inlet 35 flows by gravity through the perforated screen 41, from the inlet 35 to the second outlet 49, and feeds the liquid recirculation circuit 27 (visible in FIG. 1).

It should be noted that the solid/liquid separation module 33 can be produced by any separation system known to a person skilled in the art, apt to separate solid matter from liquid matter, in particular e.g. a centrifuge system.

The solid/liquid separation filter 25 can include a cleaning nozzle 51 connected to the water inlet 17 (visible in FIG. 1) by means of a cleaning pipe 53 connecting the cleaning nozzle 51 to the water inlet 17. A cleaning valve 55 (visible in FIG. 1) e.g. an electrically controlled hydraulic valve, is mounted on the cleaning pipe 53 in order to control the water supply of the cleaning nozzle 51 via the water inlet 17. The cleaning nozzle 51 is mounted inside the rotary screen 39.

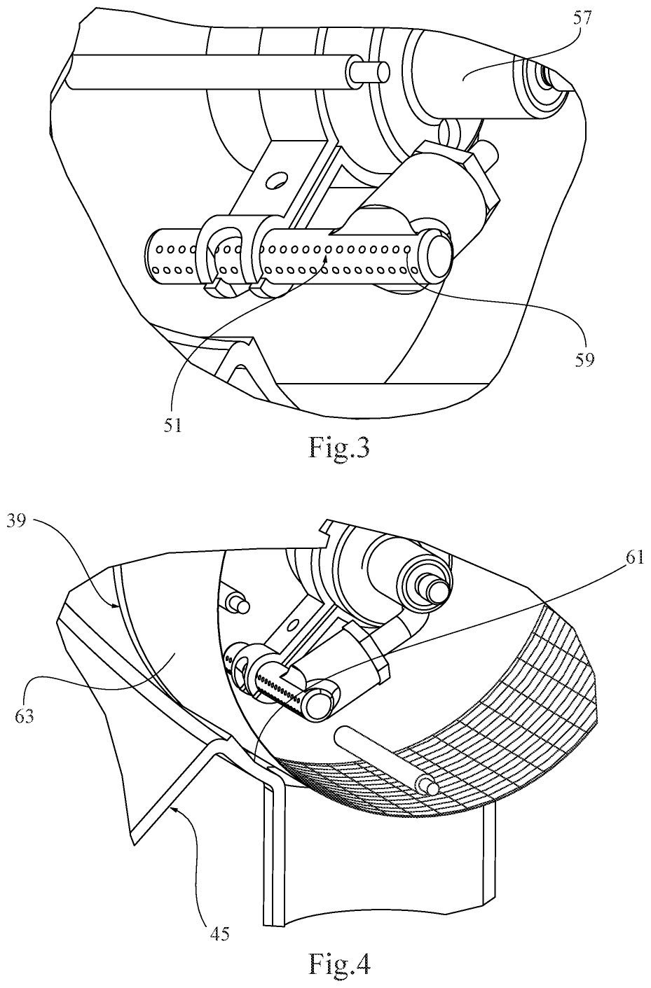

As shown in FIG. 3, which shows an enlargement of the zone III of FIG. 2, the cleaning nozzle 51 is fastened to a shaft 57 of the filtration module and in general has a cylindrical shape. The nozzle 51 has a set of holes 59, distributed around the circumference of the nozzle 51, for spraying water onto the rotary screen in order to clean the screen.

In one embodiment of the solid/liquid separation filter 33 shown in FIG. 4, the casing 31 includes, in the inner part thereof, a scraping ramp 61 arranged between the first outlet 45 and the second outlet 49. In this way, when the screen 39 is rotated by the motor, the solid matter which remain on an outer wall 63 of the screen at the moment when the screen encounters the scraping ramp 61 is discharged into the first outlet 45, in order to be routed into the discharge pipe.

According to another example, the filter 25 includes a mini-centrifuge, or a filter mat or a rotary screen filter, such as drum rotary filter or a stationary screen filter.

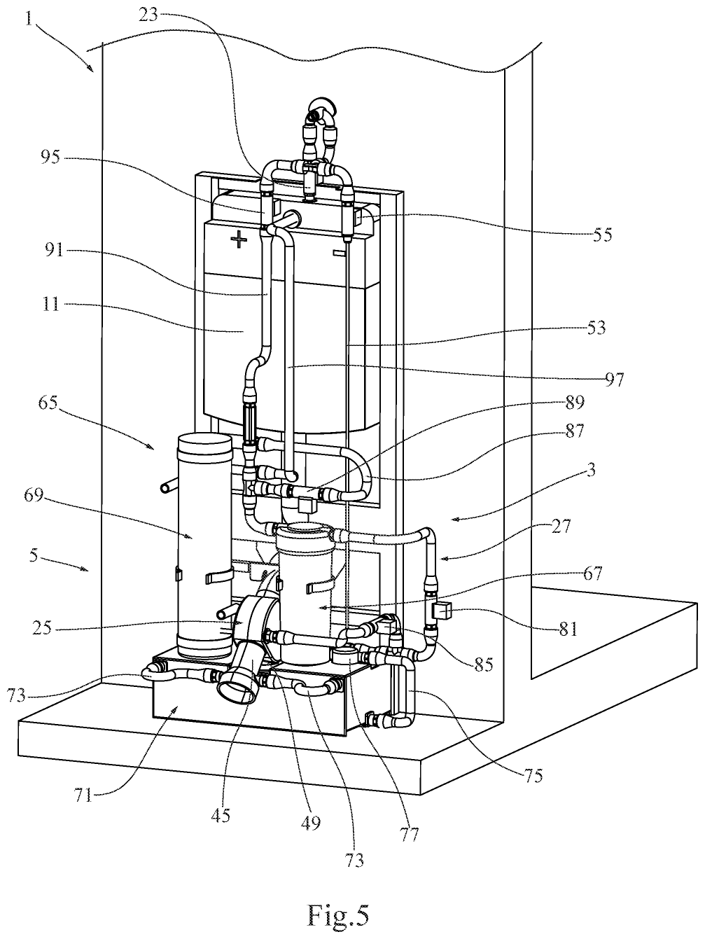

Reference is now made to FIGS. 5 and 6, illustrating the sanitary unit 1 in rear isometric view and a hydraulic diagram of the sanitary unit, respectively, for describing the liquid recirculation circuit 27 of the installation 5.

The liquid recirculation circuit 27 is arranged in the installation for conveying the liquid coming from the solid/liquid separation filter 25 to the main tank 11 of the WC 3, so that the liquid matter recovered by the filter 25 can be reused.

To this end, the liquid recirculation circuit 27 includes a filtration unit 65 designed for making the liquid coming from the solid/liquid separation filter 25 reusable after the liquid has gone through the filtration unit 65.

To this end, the filtration unit 65 includes a prefiltration system 67 and an ultrafiltration system 69, mounted in series with respect to each other.

The prefiltration system 67 provides a first filtration of the liquid matter to be sanitized, coming from the solid/liquid separation filter 25.

As an example, the prefiltration system 67 includes a cartridge filter, such as the filter used in swimming pools. Such a filter ensures the filtration of particles with a minimum size equal to 50 micrometers, i.e. such filter does not retain particles with a size smaller than 50 micrometers. Preferentially, the filter ensures a filtration of particles with a minimum size equal to 5 micrometers. The filter is e.g. a pleated cartridge filter, either made of 5 micrometer polypropylene or 5 micrometer polyester. In a variant, the filter is a media filter. The filter can be a loaded media filter suitable for the filtration of particles with a minimum size equal to 5 micrometers. In a variant, the media filter is an activated carbon filter filtering particles with a minimum size of 5 micrometers. Any other type of filter suitable for the particles contained in the liquid and making the latter usable does not depart from the scope of the present application.

The ultrafiltration system 69 provides a second filtration of the liquid matter to be sanitized, coming from the solid/liquid separation filter 25 and then from the prefiltration system 67.

The ultrafiltration system 69 can be obtained by a membrane ultrafilter, such as the filter used in the food industry and in the medical field for blood filtration.

For example, the ultrafiltration system includes a pleated cartridge filter, either made of polypropylene apt to filter particles with a minimum size of 0.2 micrometers or forming a glass fibre membrane apt to filter particles with a minimum size of 0.2 micrometers, or made of polyester apt to filter particles with a minimum size of 0.2 micrometers. In a variant, the ultrafiltration system, further or instead, includes an ozone treatment and/or a reverse osmosis system.

Preferentially, the filter 25 is a rotary screen filter, the filter of the prefiltration system 65 is a 5 micrometer activated carbon filter and the ultrafiltration system comprises a 0.2 micrometer pleated cartridge membrane filter.

It has been found that when the liquid matter coming from the solid/liquid separation filter 25 first flows through the prefiltration system 67 and then the ultrafiltration system 69, the liquid matter coming out is reusable water meeting the sanitary standards in force in the most strict countries.

Thereby, water coming from the filtration unit 65 can be conveyed to the main tank 11 of the WC 3.

The liquid recirculation circuit 27 is arranged in the installation 5 for conveying the liquid matter coming from the solid/liquid separation filter 25 to the main tank 11 after having gone through the filtration unit 65.

The installation 5 includes a tank 71 for storing liquid substances, mounted at the outlet of the solid/liquid separation filter 25 and fed with liquid matter via the second outlet 49 of the separation filter 25.

As illustrated in FIG. 7, the tank 71 for storing liquid matter can have an overall parallelepiped shape and includes an upper cover 66 having an opening 68 dimensioned for receiving the second outlet of the solid/liquid separation filter 25. The solid/liquid separation filter 25 can include two attachment arms 70, 72 for attaching the prefiltration system 67 and the ultrafiltration system 69, respectively.

Reference is made again to FIGS. 5 and 6.

The capacity of the storage tank 71 is preferentially greater than the capacity of the main tank 11. The presence of the storage tank of such a capacity, directly connected to the second outlet 49 of the separation filter 25, makes it possible to partially use the installation of the invention when the installation is not connected to the electrical mains, e.g. in the event of a power cut. Indeed, during a power cut, the separation filter 25, driven by an electric motor, would no longer work. However, the solid matter continue to slide, less rapidly, by gravity, from the inlet 35 of the separation filter to the first outlet 45, whereas the liquid matter continues to fall by gravity into the second outlet 49 of the separation filter, which conveys the liquids to the storage tank 71 where the liquid matter is stored for the duration of the power cut. In addition, the storage tank 71 can include two overflow pipes 73 connected to the second outlet 49 of the separation filter 25. As a result, the liquid matter can be conveyed to the discharge pipe 30 which can be connected to a sewer pipe, in the event of a prolonged power cut.

The liquid matter is conveyed from the storage tank 71 to the inlet of the filtration unit 65 via a prefiltration pipe 75 connecting the storage tank 71 to the prefiltration system 67.

A hydraulic pump 77 mounted on the prefiltration pipe 75 allows the liquid matter to be extracted from the storage tank 71 so that the liquid matter is displaced in the prefiltration pipe 75.

The hydraulic pump 77 is chosen so that the pressure at which the liquid matter extracted from the storage tank 71 flows through the prefiltration 67 and ultrafiltration 69 systems is sufficient for the proper functioning of the systems. In order to reduce the size of the hydraulic pump 77, it can be envisaged to mount an additional hydraulic pump at the outlet of the ultrafiltration system 69.

A non-return valve 79 is mounted at the outlet of the hydraulic pump 77, which lets a fluid flows from the hydraulic pump 77 to the prefiltration system 67.

A prefiltration valve 81, e.g. an electrically controlled hydraulic valve, can optionally be mounted on the prefiltration pipe 75, between the hydraulic pump 79 and the prefiltration system 67.

A drain pipe 83, mounted between the non-return valve 79 and the prefiltration valve 81, connects the prefiltration pipe 75 to the discharge pipe 30. A drain valve 85, e.g. an electrically controlled hydraulic valve, is mounted on the drain pipe 83.

Moreover, an ultrafiltration pipe 87 connects the prefiltration system 67 to the ultrafiltration system 69, mounted in series with respect to the prefiltration system 67, so as to convey the liquid matter from the prefiltration system 67 to the ultrafiltration system 69.

An ultrafiltration valve 89, e.g. an electrically controlled hydraulic valve, can be mounted on the ultrafiltration pipe 87, between the prefiltration system 67 and the ultrafiltration system 69.

A wash pipe 91, mounted between the prefiltration system 67 and the ultrafiltration valve 89, connects the prefiltration system 67 to the water inlet 17.

A non-return valve 93 and a wash valve 95, e.g. an electrically controlled hydraulic valve, are mounted on the wash pipe 91. The non-return valve 93 is mounted in the wash pipe 91 so as to let fluid flow from the water inlet 17 to the ultrafiltration pipe 87.

Finally, a return pipe 97 connects the ultrafiltration system 69 to the main tank 11. Thereby, the liquid recirculation circuit 27 defines a closed circuit.

The different constituent elements of the installation 5 are controlled by a programmable control unit (not shown) which can be a part of the installation 5, or external to the installation 5. The programmable control unit is configured, in particular, for managing the changes of states of the valves 23, 55, 81, 85, 89, 95, for controlling the triggering of the motor 40 and the starting of the hydraulic pump 77, for actuating the prefiltration system 67 and the ultrafiltration system 69.

The operation of the sanitary unit 1 is as follows.

When a user actuates the flush system 9, the water contained in the main tank 11 flows through the flow pipe 21 into the bowl 7.

The matter present in the bowl is extracted from the bowl 7 via the outlet 29.

The motor of the solid/liquid separation filter 25 is then actuated and controls the rotation of the screen 39. Thereby, the matter present in the bowl 7 is filtered for a first time. The solid matter is conveyed to the first outlet 45 of the filter 25 and then to the discharge pipe 30 which can be connected to a sewer pipe. The liquid matter flows through the screen of the separation filter 25 and falls by gravity into the second outlet 49 until the liquid matter reaches the storage tank 71.

The hydraulic pump 77 is then actuated, e.g. at the end of a predetermined period which could be comprised e.g. between 5 and 10 seconds. The hydraulic pump 77 then extracts the liquid matter from the storage tank 71, thereby moving the liquid matter into the prefiltration pipe 75. The liquid matter flows through the non-return valve 79 and then the prefiltration valve 81, which is normally open. The drain valve 85, normally closed, prevents at this stage the liquid matter from flowing through the drain pipe 83 connected to the discharge pipe 30. Thereby, the liquid matter reaches the prefiltration system 67 within which a second filtration takes place.

The ultrafiltration valve 89, normally open, lets the liquid matter coming from the prefiltration system 67 flow through the ultrafiltration pipe 87, whereas the non-return valve 93 prevents the liquid matter coming from the prefiltration system 67 from flowing through the wash pipe 91. The liquid matter then reaches the ultrafiltration system 69, performing a third filtration in order to obtain a reusable water.

The reusable water is then conveyed via the return pipe 97 to the main tank 11.

The installation 5 is sequenced so that the supply valve 23 closes as soon as the flush system 9 is actuated. The supply valve 23 returns to the open state thereof when the filling of the main tank 11 with the reusable water conveyed by the return pipe 97 is completed. The float valve system 24, connected to the supply valve 23, resumes the function thereof when the supply valve 23 is open. The float valve system thus makes up for the lack of water in the tank, which may occur due to losses intrinsic to the functioning of the sanitary unit.

According to an arrangement of the invention, the control unit opens the cleaning valve 55 when the flush system 9 is actuated, in order to clean the solid/liquid separation filter 25. In this way, the water coming from the water inlet 17 reaches the cleaning nozzle 51 via the cleaning pipe 53. Thereby, the cleaning nozzle 51 sprays water onto the rotating screen in order to clean same. The control unit then switches the cleaning valve 55 from the open position thereof to the closed position thereof, e.g. when the hydraulic pump 77 is switched on.

According to another arrangement of the invention, the unit formed by the washing pipe 91 and the drain pipe 83 defines a backwash system of the prefiltration system 67, the functioning of which is as follows.

The control unit is configured for simultaneously switching the state of the wash valve 95, the state of the ultrafiltration valve 89 and the state of the drain valve 85.

Such change of state takes place e.g. after a predetermined number of actuations of the flush system 9. As an example, the change of state which controls the actuation of the backwash system of the prefiltration system 67, occurs after a cycle of twenty consecutive actuations of the flush system 9.

During such change of state, the control unit simultaneously switches the wash valve 95 from the closed state thereof to the open state thereof, the ultrafiltration valve 89 from the open state thereof to the closed state thereof and the drain valve 85 from the closed state thereof to the open state thereof.

Hence the water coming from the water inlet 17 flows into the wash pipe 91 and then flows through the non-return valve 93 before arriving in counter-flow in the prefiltration system 67, the ultrafiltration valve 89 being closed.

The water loaded with impurities collected in the prefiltration system 67 then flows through the open prefiltration valve 81, then reaches the drain pipe 83 due to the presence of the non-return valve 79 in the prefiltration pipe 75 and of the drain valve 85 in the open position in the drain pipe 83. The dirty water is then conveyed through the drain pipe 83 to the discharge pipe 30 which can be connected to a sewer pipe.

The unit formed by the wash valve 95, the non-return valve 93, the ultrafiltration valve 89, the prefiltration valve 81, the non-return valve 79 and the drain valve 85 defines a unit for controlling the direction of flow of the water, arranged in the installation 5 for conveying the water from the water inlet 17 to the prefiltration system 67, then from the prefiltration system 67 to the discharge pipe 30.

The control unit is configured in such a way that the hydraulic pump does not become active until the backwash sequence is completed.

The fact of providing regular cleaning of the solid/liquid separation filter 25 and of the prefiltration system 67 optimizes the longevity of the installation 5. Furthermore, as a result, the quality of filtration operations is optimal. The quantity of water used to implement the steps of cleaning the solid/liquid separation filter 25 and of backwashing the prefiltration system 67 is negligible in terms of the saving achieved by the installation 5.

According to yet another arrangement of the invention, the unit formed by the prefiltration pipe 75, the hydraulic pump 77 and the drain pipe 83 defines a system for draining the tank 71 for storing liquid substances, the operation of which is as follows.

The control unit is set to simultaneously switch the state of the prefiltration valve 81 and the state of the drain valve 85 and to control the activation of the hydraulic pump 77.

Such change of state takes place e.g. after a predetermined number of actuations of the flush system 9. As an example, the change of state which controls the actuation of the drain system of the tank 71 for storing liquid matter, occurs after a cycle of twenty consecutive actuations of the flush system 9. The start of the cycle is e.g triggered delayed with respect to the cycle used to trigger the wash system of the prefiltration system 67.

The draining of the tank 71 can be either complete or partial.

During such change of state, the control unit simultaneously switches the prefiltration valve 81 from the open state thereof to the closed state thereof and the drain valve 85 from the closed state thereof to the open state thereof, and starts the hydraulic pump.

The liquid matter coming from the storage tank 71 flows into the prefiltration pipe 75 and then flows through the non-return valve 79 before reaching the drain pipe 83, the drain valve 85 being in the open position and the prefiltration valve being in the closed position. The liquid matter is then conveyed through the drain pipe 83 to the discharge pipe 30 which can be connected to a sewer pipe.

The unit formed by the hydraulic pump 77, the non-return valve 79, the prefiltration valve 81 and the drain valve 85 defines a unit for controlling the direction of circulation of the liquids, arranged in the installation 5 for conveying the liquid matter from the storage tank 71 to the discharge pipe 30.

According to another example, the outlet of the pipe 30 is connected to the outlet of the filter 25 in order to use all or part of the drain liquid matter for cleaning the filter 25. A valve can be provided for directing the flow of liquid matter to the filter 25 or directly to the sewer system.

In a very advantageous manner, the installation includes an electronic control unit including a computer for managing the operation of the installation, in particular the activation of the pumps and valves according to the different cycles. Furthermore, the unit provides a monitoring of the correct operation of the installation, e.g. by measuring the flow rate at different points of the circuit, which is used for detecting clogging and then triggering a backwash cleaning cycle and/or a request for maintenance.

The control unit can be in communication with a central unit which collects and monitors installation data and can arrange an intervention if the installation information so requires.

The installation according to the invention has the advantage of being easy to integrate into existing residential or industrial buildings instead of existing WCs, by installing suspended or wall WCs. It can be installed in construction projects

Of course, the present invention is not limited to the embodiments of the present installation for treating wastewater from a WC and from the present sanitary unit, described hereinabove only as illustrative examples. On the contrary, the present invention encompasses all variants involving the technical equivalents of the means described as well as the combinations thereof if such combinations fall within the scope of the invention.

1. An installation for treating wastewater from a WC, comprising:
a solid/liquid separation filter intended for being mounted at the outlet of a toilet bowl of a WC, and
a liquid recirculation circuit arranged for conveying a liquid from said solid/liquid separation filter to a main tank of said WC,
the solid/liquid separation filter including at least:
an inlet intended for being connected to the outlet of the bowl of said WC,
a solid/liquid separation module configured for separating solid matter from liquid matter,
a first outlet intended for being connected to the inlet of a discharge pipe,
a second outlet connected to said liquid recirculation circuit,
said solid/liquid separation filter being configured for conveying solid matter from said solid/liquid separation module to said first outlet and for conveying liquid matter from said solid/liquid separation module to said second outlet,
the liquid recirculation circuit comprising a filtration unit configured for making said liquid reusable for the flush system upon said liquid flowing through said filtration unit, the filtration unit of the liquid recirculation circuit including a prefiltration system and an ultrafiltration system connected in series, and said installation also including a backwash system for the prefiltration system having a supply inlet intended for being connected to a water inlet and a discharge outlet intended for being connected to the discharge pipe, the backwash system being configured for circulating water in counter-flow through the prefiltration system.

2. The installation according to claim 1, wherein the solid/liquid separation filter has a housing inside which the solid/liquid separation module is mounted, and wherein the solid/liquid separation module is a rotary screen driven by an electric motor.

3. The installation according to claim 2, wherein the solid/liquid separation filter includes a cleaning nozzle for the rotary screen and wherein said installation also includes a cleaning pipe connected at one of the ends thereof to said cleaning nozzle and intended for being connected at the other of the ends thereof to a water inlet.

4. The installation according to claim 1, including:
a storage tank for liquid matter fed by the second outlet of the solid/liquid separation filter, and
a hydraulic pump arranged for extracting the liquid matter contained in said storage tank for liquid matter.

5. The installation according to claim 4, wherein the installation includes a system for draining liquid matter from the storage tank, including:
a prefiltration pipe connecting the storage tank for liquid matter to the prefiltration system,
a drain pipe, connected to said prefiltration pipe and intended for being connected to the discharge pipe,
a unit for controlling the direction of flow of the liquid matter, arranged in the installation for conveying the liquid matter from the storage tank for liquid matter to the discharge pipe.

6. The installation according to claim 1, including a connector for temporarily connecting the outlet of the discharge pipe to the separation filter.

7. The installation according to claim 1, wherein the backwash system of the prefiltration system further comprises:
a prefiltration pipe to which the prefiltration system is connected,
a wash pipe connected to said prefiltration system and intended for being connected to a water inlet,
a drain pipe connected to said prefiltration pipe and intended for being connected to the discharge pipe,
an unit for controlling the direction of water circulation, arranged in the installation for conveying water from a water inlet to the prefiltration system, then from the prefiltration system to the discharge pipe.

8. The installation according to claim 4, wherein the storage tank includes an upper cover having an opening receiving the second outlet of the solid/liquid separation filter.

9. The installation according to claim 5, wherein the storage tank includes an upper cover having an opening receiving the second outlet of the solid/liquid separation filter.

10. A sanitary unit comprising:
a WC comprising a bowl and a flush system, said flush system comprising a main tank, said main tank being connected to a water inlet and to said bowl, and
an installation for treating wastewater from said WC, said installation comprising:
a solid/liquid separation filter intended for being mounted at the outlet of a toilet bowl of a WC, and
a liquid recirculation circuit arranged for conveying a liquid from said solid/liquid separation filter to a main tank of said WC,
the solid/liquid separation filter including at least:
an inlet intended for being connected to the outlet of the bowl of said WC,
a solid/liquid separation module configured for separating solid matter from liquid matter,
a first outlet intended for being connected to the inlet of a discharge pipe,
a second outlet connected to said liquid recirculation circuit,
said solid/liquid separation filter being configured for conveying solid matter from said solid/liquid separation module to said first outlet and for conveying liquid matter from said solid/liquid separation module to said second outlet,
the liquid recirculation circuit comprising a filtration unit configured for making said liquid reusable for the flush system upon said liquid flowing through said filtration unit, the filtration unit of the liquid recirculation circuit including a prefiltration system and an ultrafiltration system connected in series, and said installation also including a backwash system for the prefiltration system having a supply inlet intended for being connected to a water inlet and a discharge outlet intended for being connected to the discharge pipe, the backwash system being configured for circulation water in counter-flow through the prefiltration system, said liquid recirculation circuit being connected to the main tank of the WC.

11. The installation according to claim 1, wherein the solid/liquid separation filter includes two arms for attaching the prefiltration system and the ultrafiltration system.
